(19) United States
(12) Patent Application Publication
(10) Pub. No.: US 2022/0063156 A1
(43) Pub. Date: Mar. 3, 2022

(54) PLASTICIZING DEVICE, INJECTION MOLDING APPARATUS, AND THREE-DIMENSIONAL SHAPING APPARATUS

(71) Applicant: Seiko Epson Corporation, Tokyo (JP)

(72) Inventors: Hidenobu MARUYAMA, Azumino-shi (JP); Kazunobu MARUYAMA, Shiojiri-shi (JP); Masato SUGANO, Shiojiri-shi (JP)

(21) Appl. No.: 17/410,299

(22) Filed: Aug. 24, 2021

(30) Foreign Application Priority Data
Aug. 25, 2020 (JP) 2020-141532

(51) Int. Cl. B29C 45/18; B29C 45/50; B29C 45/60; B29C 45/77; B29C 64/209

(52) U.S. Cl. CPC B29C 45/18; B29C 45/5008; B29C 45/60; B29C 45/77; B33Y 30/00; B29C 2945/76006; B29C 2945/7602; B29C 2945/76832; B29C 64/209

(57) ABSTRACT

A plasticizing device includes a plasticizing section that includes a feeding port for receiving a material and plasticizes the material to generate a melted material, a material feeding section that includes a depositing port communicating with the feeding port and feeds the material from the depositing port to the plasticizing section, and a blowing section that blows gas into a feeding path connecting the depositing port and the feeding port.

The present application is based on, and claims priority from JP Application Serial Number 2020-141532, filed Aug. 25, 2020, the disclosure of which is hereby incorporated by reference herein in its entirety.

### BACKGROUND

### 1. Technical Field

The present disclosure relates to a plasticizing device, an injection molding apparatus, and a three-dimensional shaping apparatus.

### 2. Related Art

There has been known an injection molding apparatus that feeds a material plasticized by a plasticizing device to a cavity formed by a pair of molds and ejects the material from a nozzle.

For example, JP-A-2010-241016 (Patent Literature 1) describes a plasticizing and delivering device including a rotor on which a spiral groove is formed, a barrel that is in contact with an end face of the rotor, a material inflow passage communicating with the spiral groove being formed in the center of the barrel. Pellet-like resin used as a material is stored in a hopper and fed from the hopper to the radial direction outer side end portion of the spiral groove.

In the plasticizing and delivering device explained above, in some case, the vicinity of a depositing port of the hopper is clogged with the material and the material is not fed to the spiral groove.

### SUMMARY

A plasticizing device according to an aspect of the present disclosure includes: a plasticizing section that includes a feeding port for receiving a material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

An injection molding apparatus according to an aspect of the present disclosure includes: a plasticizing device that plasticizes a material into a melted material; and a nozzle that ejects, to a mold, the melted material fed from the plasticizing device. The plasticizing device includes: a plasticizing section that includes a feeding port for receiving the material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

A three-dimensional shaping apparatus according to an aspect of the present disclosure is a three-dimensional shaping apparatus that shapes a three-dimensional shaped object, the three-dimensional shaping apparatus including: a plasticizing device that plasticizes a material into a melted material; a nozzle that discharges, toward a stage, the melted material fed from the plasticizing device; and a control section. The plasticizing device includes: a plasticizing section that includes a feeding port for receiving the material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

### BRIEF DESCRIPTION OF THE DRAWINGS

FIG. 1 is a side view schematically showing an injection molding apparatus according to an embodiment.

FIG. 2 is a sectional view schematically showing the injection molding apparatus according to the embodiment.

FIG. 3 is a perspective view schematically showing a flat screw of the injection molding apparatus according to the embodiment.

FIG. 4 is a plan view schematically showing a barrel of the injection molding apparatus according to the embodiment.

FIG. 5 is a sectional view schematically showing the injection molding apparatus according to the embodiment.

FIG. 6 is a perspective view schematically showing the injection molding apparatus according to the embodiment.

FIG. 7 is a sectional view schematically showing a three-dimensional shaping apparatus according to the embodiment.

### DESCRIPTION OF EXEMPLARY EMBODIMENTS

Preferred embodiments of the present disclosure are explained in detail below with reference to the drawings. The embodiments explained below do not unduly limit the content of the present disclosure described in the appended claims. Not all of components explained below are essential constituent elements of the present disclosure.

### 1. Injection Molding Apparatus

### 1.1 Overall Configuration

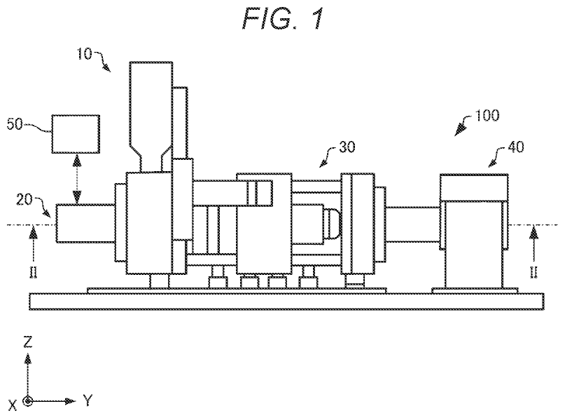

First, an injection molding apparatus according to an embodiment is explained with reference to the drawings. FIG. 1 is a side view schematically showing an injection molding apparatus 100 according to this embodiment. In FIG. 1, an X axis, a Y axis, and a Z axis are shown as three axes orthogonal to one another. An X-axis direction and a Y-axis direction are, for example, the horizontal directions. A Z-axis direction is, for example, the vertical direction.

The injection molding apparatus 100 includes, as shown in FIG. 1, an ejecting section 20, a die section 30, a die clamping section 40, and a control section 50.

The ejecting section 20 plasticizes a material fed from a material feeding section 10 into a melted material. The ejecting section 20 ejects the melted material toward the die section 30.

Plasticizing is a concept including melting and means changing a solid to a state having fluidity. Specifically, in the case of a material in which glass transition occurs, plasticizing means raising the temperature of the material to a glass transition point or higher. In the case of a material in which glass transition does not occur, plasticizing means raising the temperature of the material to a melting point or higher.

A cavity equivalent to the shape of a molded article is formed in the die section 30. The melted material ejected from the ejecting section 20 flows into the cavity. The melted material is cooled and solidified to generate the molded article.

The die clamping section 40 opens and closes the die section 30. The die clamping section 40 opens the die section after the melted material is cooled and solidified. Consequently, the molded article is discharged to the outside.

The control section 50 is configured by, for example, a computer including a processor, a main storage device, and an input and output interface that receives signals from and outputs signals to the outside. For example, the processor executes a program read to the main storage device, whereby the control section 50 exerts various functions. Specifically, the control section 50 controls the ejecting section 20 and the die clamping section 40. The control section 50 may not be configured by the computer and may be configured by a combination of a plurality of circuits. Specific control of the control section 50 is explained below.

### 1.2. Specific Configuration

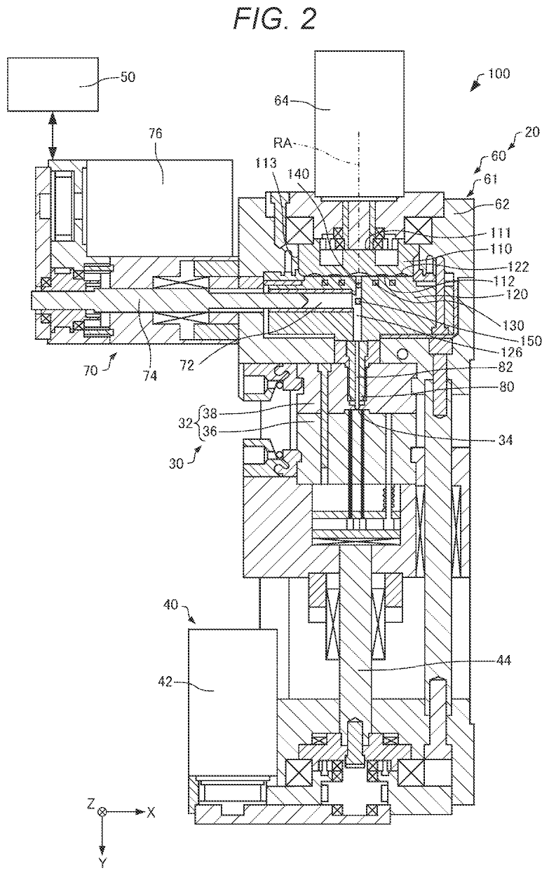

FIG. 2 is a II-II line sectional view of FIG. 1 schematically showing the injection molding apparatus 100. The ejecting section 20 includes, as shown in FIG. 2, for example, a plasticizing device 60 including a plasticizing section 61, an ejecting mechanism 70, and a nozzle 80.

The plasticizing section 61 plasticizes the material fed from the material feeding section 10 to generate a paste-like melted material having fluidity and guides the melted material to the ejecting mechanism 70. The plasticizing section 61 includes, for example, a screw case 62, a driving motor 64, a flat screw 110, a barrel 120, a heating section 130, a check valve 140, and a pressure detecting section 150.

The screw case 62 is a housing that houses the flat screw 110. The flat screw 110 is housed in a space surrounded by the screw case 62 and the barrel 120.

The driving motor 64 is provided in the screw case 62. The driving motor 64 rotates the flat screw 110. The driving motor 64 is controlled by the control section 50.

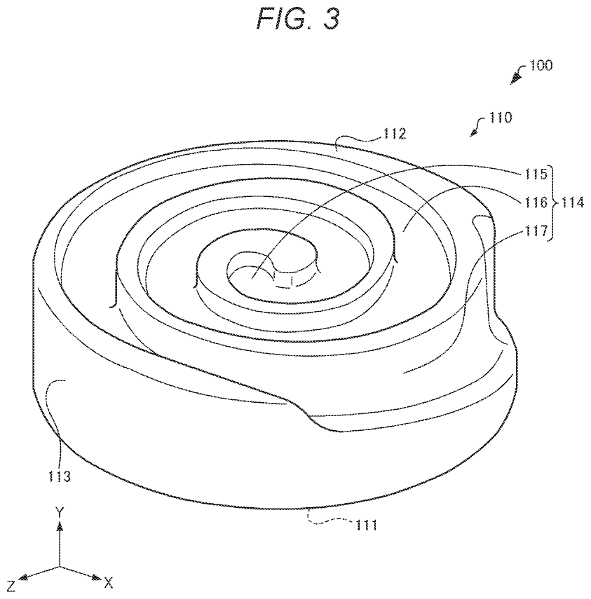

The flat screw 110 has a substantially columnar shape, the size of which in a rotation axis RA direction is smaller than the size thereof in a direction orthogonal to the rotation axis RA direction. In an illustrated example, the rotation axis RA is parallel to the Y axis. The flat screw 110 rotates around the rotation axis RA with torque generated by the driving motor 64. The flat screw 110 includes a main surface 111, a groove forming surface 112 on the opposite side of the main surface 111, and a connecting surface 113 connecting the main surface 111 and the groove forming surface 112. FIG. 3 is a perspective view schematically showing the flat screw 110. For convenience, in FIG. 3, a state in which a vertical positional relation is reversed from a state shown in FIG. 2 is shown. In FIG. 2, the flat screw 110 is simplified and illustrated.

As shown in FIG. 3, a first groove 114 is provided on the groove forming surface 112 of the flat screw 110. The first groove 114 includes, for example, a center section 115, a groove connecting section 116, and a material introducing section 117. The center section 115 is opposed to a communication hole 126 provided in the barrel 120. The center section 115 communicates with the communication hole 126. The groove connecting section 116 connects the center section 115 and the material introducing section 117. In an example shown in FIG. 3, the groove connecting section 116 is provided in a swirl shape from the center section 115 toward the outer circumference of the groove forming surface 112. The material introducing section 117 is provided on the outer circumference of the groove forming surface 112. That is, the material introducing section 117 is provided on the connecting surface 113 of the flat screw 110. The material fed from the material feeding section 10 is introduced into the first groove 114 from the material introducing section 117 and conveyed to the communication hole 126 provided in the barrel 120 through the groove connecting section 116 and the center section 115. The number of first grooves 114 is not particularly limited. Two or more first grooves 114 may be provided.

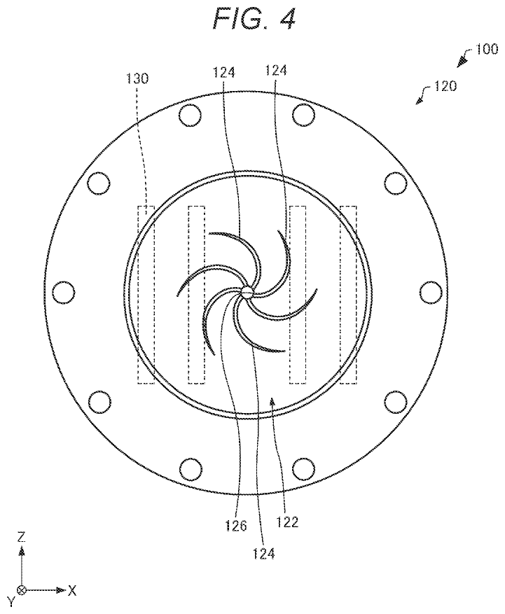

As shown in FIG. 2, the barrel 120 is provided to be connected to the flat screw 110. The barrel 120 has an opposed surface 122 opposed to the groove forming surface 112 of the flat screw 110. The communication hole 126 is provided in the center of the opposed surface 122. FIG. 4 is a plan view schematically showing the barrel 120. For convenience, in FIG. 2, the barrel 120 is simplified and illustrated.

As shown in FIG. 4, a plurality of second grooves 124 and the communication hole 126 are provided on the opposed surface 122 of the barrel 120. In an illustrated example, six second grooves 124 are provided. However, the number of second grooves 124 is not particularly limited. The plurality of second grooves 124 are provided around the communication hole 126 when viewed from the Y-axis direction. One ends of the second grooves 124 are connected to the communication hole 126. The second grooves 124 extend in a swirl shape from the communication hole 126 toward the outer circumference of the opposed surface 122. The second grooves 124 have a function of guiding the melted material to the communication hole 126.

The shape of the second grooves 124 is not particularly limited and may be, for example, a linear shape. The second grooves 124 may not be provided on the opposed surface 122. However, when considering efficiently guiding the melted material to the communication hole 126, the second grooves 124 are preferably provided on the opposed surface 122.

The heating section 130 heats a material fed to between the flat screw 110 and the barrel 120. The heating section 130 is provided in, for example, the barrel 120. In the illustrated example, the heating section 130 is configured by four heaters provided in the barrel 120. An output of the heating section 130 is controlled by the control section 50. The plasticizing section 61 heats the material while conveying the material toward the communication hole 126 with the flat screw 110, the barrel 120, and the heating section 130 to generate a melted material and causes the generated melted material to flow out from the communication hole 126 to the ejecting mechanism 70.

As shown in FIG. 2, the check valve 140 is provided in the communication hole 126. The check valve 140 prevents a backflow of the melted material from the communication hole 126 to the first groove 114 provided in the flat screw 110.

The pressure detecting section 150 is provided in the communication hole 126. The pressure detecting section 150 is a pressure sensor that detects pressure in the communication hole 126.

The ejecting mechanism 70 includes, for example, a cylinder 72, a plunger 74, and a plunger driving section 76. The cylinder 72 is a substantially cylindrical member connected to the communication hole 126. The plunger 74 moves on the inside of the cylinder 72. The plunger 74 is driven by the plunger driving section 76 configured by a motor, a gear, and the like. The plunger driving section 76 is controlled by the control section 50.

The ejecting mechanism 70 slides the plunger 74 in the cylinder 72 to thereby execute measuring operation and ejecting operation. The measuring operation indicates operation for moving the plunger 74 in a −X-axis direction away from the communication hole 126 to thereby guide the melted material located in the communication hole 126 into the cylinder 72 and measuring the melted material in the cylinder 72. The ejecting operation indicates operation for moving the plunger 74 in a +X-axis direction approaching the communication hole 126 to thereby eject the melted material in the cylinder 72 to the die section 30 via the nozzle 80.

A nozzle hole 82 communicating with the communication hole 126 is provided in the nozzle 80. The melted material fed from the plasticizing section 61 is ejected to a molding die 32 of the die section 30 through the nozzle hole 82. Specifically, the measuring operation and the ejecting operation explained above are executed, whereby the melted material measured in the cylinder 72 is sent from the ejecting mechanism 70 to the nozzle hole 82 via the communication hole 126. The melted material is ejected to the die section 30 from the nozzle hole 82.

The die section 30 includes the molding die 32. The molding die 32 is a mold. The melted material sent to the nozzle hole 82 is ejected to a cavity 34 of the molding die 32 from the nozzle hole 82. Specifically, the molding die 32 includes a movable die 36 and a stationary die 38 opposed to each other and includes the cavity 34 between the movable die 36 and the stationary die 38. The cavity 34 is a space equivalent to the shape of the molded article. The material of the movable die 36 and the stationary die 38 is metal. The material of the movable die 36 and the stationary die 38 may be ceramics or resin.

The die clamping section 40 includes, for example, a die driving section 42 and a ball screw section 44. The die driving section 42 is configured by, for example, a motor and a gear. The die driving section 42 is connected to the movable die 36 via the ball screw section 44. Driving of the die driving section 42 is controlled by the control section 50. The ball screw section 44 transmits power generated by the driving of the die driving section 42 to the movable die 36. The die clamping section 40 moves the movable die 36 with the die driving section 42 and the ball screw section 44 to thereby open and close the die section 30.

### 1.3. Blowing Section and the Like

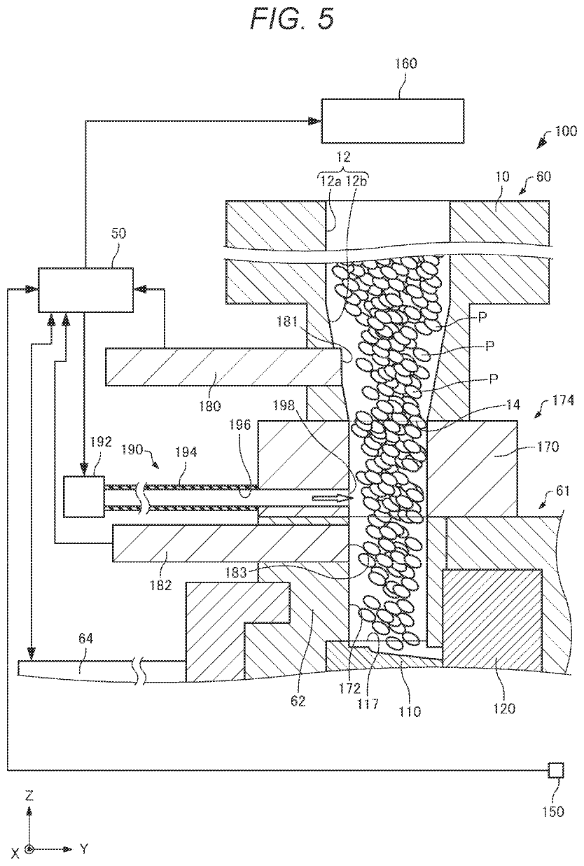

FIG. 5 is a sectional view schematically showing the plasticizing device 60 of the injection molding apparatus 100 and is a sectional view of the injection molding apparatus 100 shown in FIG. 1 taken along a plane parallel to a YZ plane including the Y axis and the Z axis.

The plasticizing device 60 includes, as shown in FIG. 5, the material feeding section 10 and the plasticizing section 61 explained above, a material supply section 160, a coupling section 170, a first material detecting section 180, a second material detecting section 182, and a blowing section 190. For convenience, in FIG. 1, illustration of the material supply section 160 is omitted.

The material supply section 160 supplies a material P to the material feeding section 10. In an illustrated example, the material P is a pellet-like material. The material P is, for example, an MIM (Metal Injection Molding) material containing metal particles and thermoplastic resin.

Examples of the material of the metal particles contained in the material P include single metal such as magnesium (Mg), iron (Fe), cobalt (Co), chrome (Cr), aluminum (Al), titanium (Ti), copper (Cu), and nickel (Ni), an alloy containing one or more of these kinds of metal, maraging steel, stainless steel, cobalt chrome molybdenum, a titanium alloy, a nickel alloy, an aluminum alloy, a cobalt alloy, and a cobalt chrome alloy.

Examples of the thermoplastic resin contained in the material P include general-purpose engineering plastic such as polypropylene (PP), polyethylene (PE), polyacetal (POM), poly vinyl chloride (PVC), polyamide (PA), acrylonitrile butadiene styrene (ABS), polylactic acid (PLA), polyphenylene sulfide (PPS), polycarbonate (PC), modified polyphenylene ether, polybutylene terephthalate, and polyethylene terephthalate and engineering plastic such as polysulfone, polyether sulfone, polyphenylene sulfide, polyarylate, polyimide, polyamide imide, polyether imide, and polyether ether ketone (PEEK).

The material P is supplied to the material feeding section 10 from the material supply section 160. The material feeding section 10 feeds the supplied material P to the plasticizing section 61. For example, a hopper is used as the material feeding section 10. A hollow 12, through which the material P passes, is provided in the material feeding section 10. The hollow 12 includes a fixed width section 12a, the size of which in the Y-axis direction is fixed, and a reverse taper section 12b, the size of which in the Y-axis direction gradually decreases toward a −Z-axis direction. The material feeding section 10 includes a depositing port 14 communicating with the material introducing section 117. In the illustrated example, the depositing port 14 is the end in the −Z-axis direction of the reverse taper section 12b. The material feeding section 10 feeds the material P from the depositing port 14 to the plasticizing section 61 via the coupling section 170.

The coupling section 170 couples the material feeding section 10 and the plasticizing section 61. The shape of the coupling section 170 is, for example, a plate shape. A feeding path 172 functioning as a path for the material P is provided in the coupling section 170. The feeding path 172 connects the depositing port 14 and the material introducing section 117. The depositing port 14 and the material introducing section 117 communicate via the feeding path 172. In the illustrated example, the feeding path 172 is provided at fixed width from the depositing port 14 to the material introducing section 117. The material introducing section 117 of the plasticizing section 61 is a supply port for receiving the material P. In the illustrated example, the feeding path 172 is provided in the coupling section 170 and the screw case 62. The coupling section 170 and the material feeding section 10 configure a material feeding device 174 that feeds the material P to the plasticizing section 61.

The first material detecting section 180 detects the material P in the material feeding section 10. The first material detecting section 180 is supported by, for example, the material feeding section 10. A distal end 181 of the first material detecting section 180 is located in the reverse taper section 12b of the hollow 12 provided in the material feeding section 10. The first material detecting section 180 detects presence or absence of the material P in the material feeding section 10. The first material detecting section 180 is a proximity sensor such as a high-frequency induction type proximity sensor or a capacitance type proximity sensor.

The second material detecting section 182 detects the material P in the feeding path 172. The second material detecting section 182 is supported by, for example, the plasticizing section 61. A distal end 183 of the second material detecting section 182 is located in the feeding path 172 provided in the plasticizing section 61. The second material detecting section 182 detects presence or absence of the material P in the feeding path 172. The second material detecting section 182 is a proximity sensor such as a high-frequency induction type proximity sensor or a capacitance type proximity sensor.

The first material detecting section 180 and the second material detecting section 182 may be a weight sensor or a pressure sensor and may detect a residual amount of the material P by converting the residual amount into a numerical value. One or both of the first material detecting section 180 and the second material detecting section 182 may not be provided. However, in order to surely detect material shortage, both of the first material detecting section 180 and the second material detecting section 182 are preferably provided.

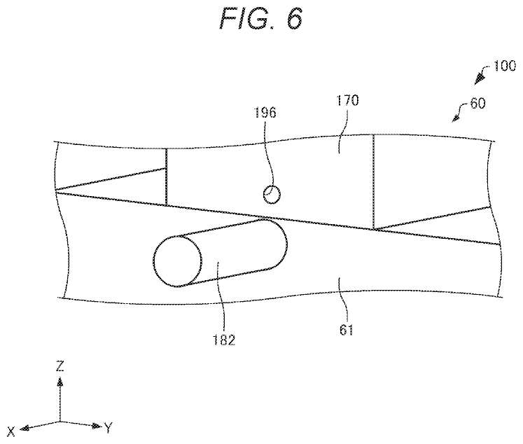

The blowing section 190 blows gas into the feeding path 172. The blowing section 190 includes, for example, a pump 192 and a hose 194. The hose 194 defines a blowing path 196 for sending gas from the pump 192. FIG. 6 is a perspective view schematically showing the plasticizing device 60. In examples shown in FIGS. 5 and 6, the blowing path 196 is further defined by the coupling section 170. For convenience, in FIG. 6, illustration of the hose 194 is omitted.

The blowing path 196 of the blowing section 190 communicates with the feeding path 172. The blowing section 190 blows gas into the feeding path 172 from a blowing port 198. The blowing port 198 is the end on the feeding path 172 side of the blowing path 196. In the illustrated example, the blowing port 198 is the end in a +Y-axis direction of the blowing path 196. The blowing port 198 is provided between the second material detecting section 182 and the depositing port 14 in the feeding path 172. The blowing port 198 is located further on the depositing port 14 side than the second material detecting section 182. The blowing port 198 is located further on the upstream of the feeding path 172 than the distal end 183 of the second material detecting section 182. In the illustrated example, the blowing port 198 is located further on a +Z-axis direction than the distal end 183.

The blowing section 190 blows gas into the feeding path 172 in a direction crossing the feeding path 172. In the illustrated example, the blowing section 190 blows the gas in the +Y-axis direction. The material P moves in the −Z-axis direction in the feeding path 172 to be fed to the plasticizing section 61.

The gas blown from the blowing section 190 is, for example, air. The gas blown from the blowing section 190 is preferably dried air. Consequently, it is possible to prevent the material P from reacting with moisture contained in the gas. A method of drying the air is not particularly limited. Examples of the method include drying by a molecular sieve.

The gas blown from the blowing section 190 may be rare gas such as argon. Consequently, it is possible to prevent the material P from reacting with oxygen contained in the gas. For example, when the material P contains thermoplastic resin, the material P is chemically unstable and sometimes reacts with the oxygen in the air.

### 1.4. Control Section

The control section 50 controls the blowing section 190 based on, for example, a detection result of the pressure detecting section 150. Specifically, when pressure detected by the pressure detecting section 150 is smaller than a predetermined value, the control section 50 starts the blowing section 190. The blowing section 190 is controlled based on the detection result of the pressure detecting section 150 and is started when the pressure detected by the pressure detecting section 150 is smaller than the predetermined value. When the pressure detected by the pressure detecting section 150 is smaller than the predetermined value, it is likely that the feeding path 172 is clogged with the material P and the material P is not fed to the material introducing section 117. Therefore, the clogging of the material P in the feeding path 172 can be detected by the detection of the pressure detecting section 150. Since the width of the hollow 12 decreases, in particular, near the depositing port 14, the hollow 12 is easily clogged with the material P. When the pressure detected by the pressure detecting section 150 is smaller than the predetermined value, the control section 50 starts the blowing section 190 to blow gas to the feeding path 172 and eliminates the clogging of the material P with the air pressure of the gas. When the pressure detected by the pressure detecting section 150 is changed to a normal value larger than the predetermined value by starting the blowing section 190, the control section 50 stops the blowing by the blowing section 190.

The control section 50 controls the blowing section 190 based on, for example, the rotation of the flat screw 110. Specifically, the control section 50 acquires a torque value of the driving motor 64 and, when the acquired torque value is smaller than a predetermined value, starts the blowing section 190. The blowing section 190 is controlled based on the rotation of the flat screw 110 and started when the torque value of the driving motor 64 is smaller than the predetermined value. When the torque value of the driving motor 64 is smaller than the predetermined value, since the feeding path 172 is clogged with the material P and the material P is not supplied to the material introducing section 117, it is likely that the flat screw 110 is idling. Therefore, the clogging of the material P in the feeding path 172 can be detected according to the torque value of the driving motor 64. When the torque value of the driving motor 64 is smaller than the predetermined value, the control section 50 starts the blowing section 190 to blow gas to the feeding path 172 and eliminates the clogging of the material P. When the torque value of the driving motor 64 is changed to a normal value larger than the predetermined value by starting the blowing section 190, the control section 50 stops the blowing by the blowing section 190. The blowing section 190 may continuously blow the gas to the feeding path 172 irrespective of the detection result of the pressure detecting section 150 or the rotation of the flat screw 110.

The control section 50 controls the material supply section 160 to supply the material P to the material feeding section 10 based on, for example, a detection result of the first material detecting section 180. The material supply section 160 supplies the material P to the material feeding section 10 based on the detection result of the first material detecting section 180. Specifically, when the first material detecting section 180 detects material shortage, the control section 50 drives the material supply section 160 to feed the material P to the material feeding section 10. Consequently, it is possible to eliminate the material shortage of the material feeding section 10.

The control section 50 controls, for example, the flat screw 110. Specifically, when the second material detecting section 182 detects material shortage, the control section 50 controls the driving motor 64 to stop the rotation of the flat screw 110. When the second material detecting section 182 detects material shortage, the flat screw 110 stops rotating. Consequently, it is possible to prevent the flat screw 110 from idling.

In the above explanation, an example is explained in which one control section 50 performs the control of the blowing section 190 based on the detection result of the pressure detecting section 150, the control of the blowing section 190 based on the rotation of the flat screw 110, the control of the material supply section 160 based on the detection result of the first material detecting section 180, and the control of the flat screw 110 based on the detection result of the second material detecting section 182. However, separate control sections may be provided for each of the controls. When considering a reduction in the size of the apparatus, it is preferable to perform the controls with one control section. The control section 50 may perform all of the controls or may perform any one of the controls. The number of controls is not particularly limited.

### 1.5. Action Effects

The plasticizing device 60 includes the plasticizing section 61 that includes the material introducing section 117 functioning as the feeding port for receiving the material P and plasticizes the material P to generate a melted material, the material feeding section 10 that includes the depositing port 14 communicating with the material introducing section 117 and feeds the material P from the depositing port 14 to the plasticizing section 61, and the blowing section 190 that blows gas into the feeding path 172 connecting the depositing port 14 and the material introducing section 117. Accordingly, in the plasticizing device 60, even if the feeding path 172 is clogged with the material P, it is possible to agitate the material P with the gas blown from the blowing section 190 and eliminate the clogging of the material P. Consequently, it is possible to prevent a bridge phenomenon from occurring because the material P is not fed to the plasticizing section 61.

Further, in the plasticizing device 60, the material P can be cooled by the gas blown from the blowing section 190. Consequently, it is possible to prevent the material P from melting and condensing in the feeding path 172. When the material P condenses in the feeding path 172, clogging easily occurs.

Further, in the plasticizing device 60, clogging of the material P can be eliminated by providing the blowing section 190. Accordingly, it is possible to achieve a reduction in the size of the device compared with when the material P in the feeding path 172 is mechanically agitated to eliminate the clogging.

The plasticizing device 60 includes the first material detecting section 180 that detects the material P in the material feeding section 10 and the material supply section 160 that supplies the material P to the material feeding section 10. The material supply section 160 supplies the material P to the material feeding section 10 based on a detection result of the first material detecting section 180. Accordingly, in the plasticizing device 60, when the first material detecting section 180 detects material shortage, the material P is automatically supplied to the material feeding section 10 by the material supply section 160. Consequently, it is possible to save time for feeding the material P to the material feeding section 10.

In the plasticizing device 60, the flat screw 110 has the groove forming surface 112 on which the first groove 114 is provided, the first groove 114 includes the material introducing section 117, the plasticizing section 61 includes the barrel 120 having the opposed surface 122 opposed to the groove forming surface 112, and the communication hole 126 communicating with the first groove 114 is provided on the opposed surface 122. Accordingly, in the plasticizing device 60, it is possible to feed the material P to the communication hole 126 via the first groove 114. Further, it is possible to achieve space saving compared with when a bar-like inline screw long in the rotation axis RA direction is used as a screw.

The plasticizing device 60 includes the pressure detecting section 150 that detects pressure in the communication hole 126. The blowing section 190 is controlled based on a detection result of the pressure detecting section 150. In the plasticizing device 60, clogging of the material P in the feeding path 172 can be detected according to the detection result of the pressure detecting section 150. It is possible to eliminate the clogging of the material P with the blowing section 190.

In the plasticizing device 60, the blowing section 190 is started when the pressure detected by the pressure detecting section 150 is smaller than a predetermined value. Accordingly, in the plasticizing device 60, it is possible to eliminate clogging of the material P.

In the plasticizing device 60, the blowing section 190 is controlled based on rotation of the flat screw 110. In the plasticizing device 60, clogging of the material P in the feeding path 172 can be detected according to the rotation of the flat screw 110. It is possible to eliminate the clogging of the material P with the blowing section 190.

In the plasticizing device 60, the blowing section 190 is started when a torque value of the driving motor 64 is smaller than a predetermined value. Accordingly, in the plasticizing device 60, it is possible to eliminate clogging of the material P.

The plasticizing device 60 includes the second material detecting section 182 that detects the material P in the feeding path 172. When the second material detecting section 182 detects material shortage, the rotation of the flat screw 110 is stopped. Accordingly, in the plasticizing device 60, it is possible to prevent the flat screw 110 from idling.

In the plasticizing device 60, the blowing section 190 blows gas into the feeding path 172 from the blowing port 198. The blowing port 198 is provided between the second material detecting section 182 and the depositing port 14 in the feeding path 172. Accordingly, in the plasticizing device 60, it is possible to make it less likely that the material P is blown up by the gas blown from the blowing section 190 and the second material detecting section 182 malfunctions.

In the plasticizing device 60, the material feeding section 10 feeds the material P containing the metal particles and the thermoplastic resin. Such a material P made of the MIM material has larger mass and clogging more easily occurs compared with, for example, a material made of only resin. However, in the plasticizing device 60, even if such a MIM material is used, it is possible to eliminate clogging of the material P with gas blown from the blowing section 190. Further, the material P made of the MIM material has higher thermal conductivity compared with, for example, a material made of only resin. Accordingly, heat of the plasticizing section 61 is easily transmitted to the material P and the material P easily melts and condenses. However, in the plasticizing device 60, since the material P can be cooled by the gas blown from the blowing section 190, it is possible to prevent the material P from melting even if such an MIM material is used.

Ceramics may be mixed in the material P besides the metal particles and the thermoplastic resin. Examples of the ceramics include oxide ceramics such as silicon dioxide, titanium dioxide, aluminum oxide, and zirconium oxide and non-oxide ceramics such as aluminum nitride. Further, for example, an additive such as pigment, wax, flame retardant, antioxidant, and heat stabilizer may be mixed in the material P.

Further, a binder may be added to the material P. Examples of the binder include acrylic resin, epoxy resin, silicone resin, cellulose resin, and other kinds of synthetic resin and PLA (polylactic acid), PA (polyamide), PPS (polyphenylene sulfide), and PEEK (polyether ether ketone).

In the example explained above, the flat screw 110, the size of which in the rotation axis RA direction is smaller than the size thereof in the direction orthogonal to the rotation axis RA direction, is used as the screw. However, a bar-like inline screw long in the rotation axis RA direction may be used instead of the flat screw 110.

In the above explanation, an example is explained in which the injection molding apparatus 100 includes the control section 50 and the plasticizing device 60 does not include a control section. However, the plasticizing device 60 may include the control section 50.

### 2. Three-Dimensional Shaping Apparatus

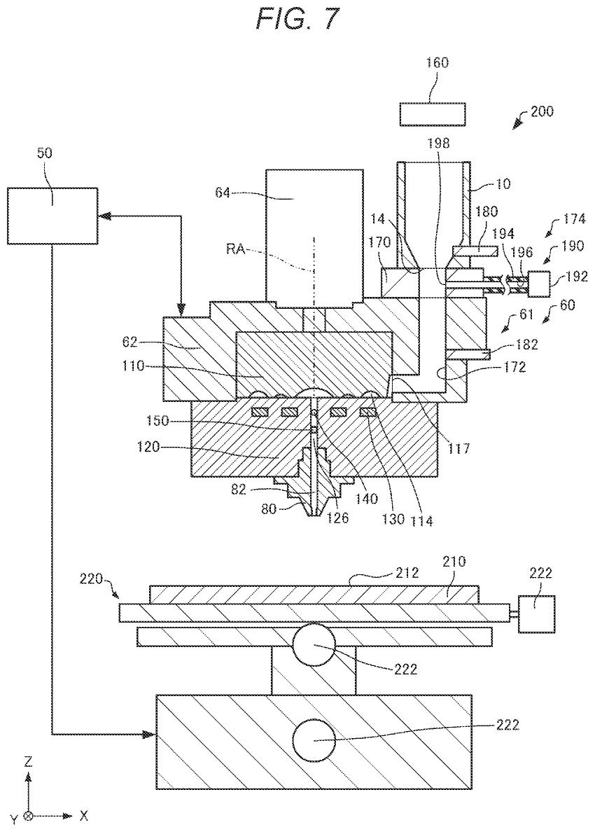

A three-dimensional shaping apparatus according to this embodiment is explained with reference to the drawings. FIG. 7 is a side view schematically showing a three-dimensional shaping apparatus 200 according to this embodiment.

The three-dimensional shaping apparatus 200 includes, for example, as shown in FIG. 7, the plasticizing device 60, the nozzle 80, a stage 210, a moving mechanism 220, and the control section 50. For convenience, in FIG. 7, illustration of the material P is omitted.

The plasticizing device 60 includes the material feeding section 10, the plasticizing section 61, the material supply section 160, the coupling section 170, the first material detecting section 180, the second material detecting section 182, and the blowing section 190. The plasticizing section 61 includes the screw case 62, the driving motor 64, the flat screw 110, the barrel 120, the heating section 130, the check valve 140, and the pressure detecting section 150.

The nozzle 80 discharges, toward the stage 210, a melted material supplied from the plasticizing device 60. Specifically, the three-dimensional shaping apparatus 200 drives the moving mechanism 220 while discharging the melted material from the nozzle 80 to the stage 210 and changes relative positions of the nozzle 80 and the stage 210. Consequently, the three-dimensional shaping apparatus 200 shapes a three-dimensional shaped object having a desired shape on the stage 210.

The stage 210 is moved by the moving mechanism 220. The three-dimensional shaped object is formed on a shaping surface 212 of the stage 210.

The moving mechanism 220 changes the relative positions of the nozzle 80 and the stage 210. In an illustrated example, the moving mechanism 220 moves the stage 210 with respect to the nozzle 80. The moving mechanism 220 is configured by a three-axis positioner that moves the stage 210 in the X-axis direction, the Y-axis direction, and the Z-axis direction with, for example, driving forces of three motors 222. The motors 222 are controlled by the control section 50.

The moving mechanism 220 may be configured not to move the stage 210 but to move the nozzle 80. Alternatively, the moving mechanism 220 may be configured to move both of the nozzle 80 and the stage 210.

The control section 50 controls the moving mechanism 220 and the plasticizing device 60 based on shaping data acquired in advance to thereby discharge the melted material from the nozzle 80 to a predetermined position on the stage 210 to shape a three-dimensional shaped object.

In the above explanation, an example is explained in which the three-dimensional shaping apparatus 200 includes the control section 50 and the plasticizing device 60 does not include a control section. However, the plasticizing device 60 may include the control section 50.

The present disclosure includes substantially the same configurations as the configurations explained in the embodiment, for example, configurations having the same functions, methods, and results as the functions, the methods, and the results of the configurations explained in the embodiment or configurations having the same objects and effects as the objects and the effects of the configurations explained in the embodiment. The present disclosure includes configurations obtained by replacing nonessential portions of the configurations explained in the embodiment. The present disclosure includes configurations that can achieve the same action effects as the action effects of the configurations explained in the embodiment or configurations that can achieve the same objects as the objects of the configurations explained in the embodiment. The present disclosure includes configurations obtained by adding publicly-known techniques to the configurations explained in the embodiment.

Contents described below are derived from the embodiment explained above.

A plasticizing device according to an aspect of the present disclosure includes: a plasticizing section that includes a feeding port for receiving a material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

With the plasticizing device, even if the feeding path is clogged with the material, it is possible to agitate the material with the gas blown from the blowing section and eliminate the clogging of the material. Consequently, it is possible to prevent a bridge phenomenon from occurring because the material is not fed to the plasticizing mechanism.

In the plasticizing device according to the aspect, the plasticizing device may further include: a first material detecting section that detects the material in the material feeding section; and a material supply section that supplies the material to the material feeding section, and the material supply section may supply the material to the material feeding section based on a detection result of the first material detecting section.

With the plasticizing device, when the first material detecting section detects material shortage, the material is automatically supplied to the material feeding section by the material supply section. Therefore, it is possible to save time for supplying the material to the material feeding section.

In the plasticizing device according to the aspect, the plasticizing section may include: a driving motor; and a screw rotated by the driving motor.

In the plasticizing device according to the aspect, the screw may have a groove forming surface on which a groove is provided, the groove may include the feeding port, the plasticizing section may include a barrel having an opposed surface opposed to the groove forming surface, and a communication hole communicating with the groove may be provided on the opposed surface.

With the plasticizing device, it is possible to feed the material to the communication hole via the groove.

In the plasticizing device according to the aspect, the plasticizing device may further include a pressure detecting section that detects pressure in the communication hole, and the blowing section may be controlled based on a detection result of the pressure detecting section.

With the plasticizing device, clogging of the material in the feeding path can be detected according to the detection result of the pressure detecting section. It is possible to eliminate the clogging of the material with the blowing section.

In the plasticizing device according to the aspect, the blowing section may be started when the pressure detected by the pressure detecting section is smaller than a predetermined value.

With the plasticizing device, it is possible to eliminate clogging of the material.

In the plasticizing device according to the aspect, the blowing section may be controlled based on the rotation of the screw.

With the plasticizing device, clogging of the material in the feeding path can be detected according to the rotation of the screw. It is possible to eliminate the clogging of the material P with the blowing section.

In the plasticizing device according to the aspect, the blowing section may be started when a torque value of the driving motor is smaller than a predetermined value.

With the plasticizing device, it is possible to eliminate clogging of the material.

In the plasticizing device according to the aspect, the plasticizing device may further include a second material detecting section that detects the material in the feeding path, and the rotation of the screw may be stopped when the second material detecting section detects material shortage.

With the plasticizing device, it is possible to prevent the screw from idling.

In the plasticizing device according to the aspect, the blowing section may blow the gas into the feeding path from a blowing port, and the blowing port may be provided between the second material detecting section and the depositing port side in the feeding path.

With the plasticizing device, it is possible to make it less likely that the material is blown up by the gas blown from the blowing section and the second material detecting section malfunctions.

In the plasticizing device according to the aspect, the material feeding section may feed the material containing metal particles and thermoplastic resin.

With the plasticizing device, even if an MIM material with which clogging easily occurs is used, it is possible to eliminate clogging of the material with the gas blown from the blowing section.

An injection molding apparatus according to an aspect of the present disclosure includes: a plasticizing device that plasticizes a material into a melted material; and a nozzle that ejects, to a mold, the melted material fed from the plasticizing device. The plasticizing device includes: a plasticizing section that includes a feeding port for receiving the material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

A three-dimensional shaping apparatus according to an aspect of the present disclosure is a three-dimensional shaping apparatus that shapes a three-dimensional shaped object, the three-dimensional shaping apparatus including: a plasticizing device that plasticizes a material into a melted material; a nozzle that discharges, toward a stage, the melted material fed from the plasticizing device; and a control section. The plasticizing device includes: a plasticizing section that includes a feeding port for receiving the material and plasticizes the material to generate a melted material; a material feeding section that includes a depositing port communicating with the feeding port and feeds the material from the depositing port to the plasticizing section; and a blowing section that blows gas into a feeding path connecting the depositing port and the feeding port.

What is claimed is:

1. A plasticizing device comprising:
a plasticizing section that includes a feeding port for receiving a material and plasticizes the material to generate a melted material;
a material feeding section that includes a depositing port communicating with the feeding port and feeds the material from the depositing port to the plasticizing section; and
a blowing section that blows gas into a feeding path connecting the depositing port and the feeding port.

2. The plasticizing device according to claim 1, further comprising:
a first material detecting section that detects the material in the material feeding section; and
a material supply section that supplies the material to the material feeding section, wherein
the material supply section supplies the material to the material feeding section based on a detection result of the first material detecting section.

3. The plasticizing device according to claim 1, wherein the plasticizing section includes:
a driving motor; and
a screw rotated by the driving motor.

4. The plasticizing device according to claim 3, wherein
the screw has a groove forming surface on which a groove is provided,
the groove includes the feeding port,
the plasticizing section includes a barrel having an opposed surface opposed to the groove forming surface, and
a communication hole communicating with the groove is provided on the opposed surface.

5. The plasticizing device according to claim 4, further comprising a pressure detecting section that detects pressure in the communication hole, wherein
the blowing section is controlled based on a detection result of the pressure detecting section.

6. The plasticizing device according to claim 5, wherein the blowing section is started when the pressure detected by the pressure detecting section is smaller than a predetermined value.

7. The plasticizing device according to claim 3, wherein the blowing section is controlled based on the rotation of the screw.

8. The plasticizing device according to claim 7, wherein the blowing section is started when a torque value of the driving motor is smaller than a predetermined value.

9. The plasticizing device according to claim 3, further comprising a second material detecting section that detects the material in the feeding path, wherein
the rotation of the screw is stopped when the second material detecting section detects material shortage.

10. The plasticizing device according to claim 9, wherein
the blowing section blows the gas into the feeding path from a blowing port, and
the blowing port is provided between the second material detecting section and the depositing port side in the feeding path.

11. The plasticizing device according to claim 1, wherein the material feeding section feeds the material containing metal particles and thermoplastic resin.

12. An injection molding apparatus comprising:
a plasticizing device that plasticizes a material into a melted material; and
a nozzle that ejects, to a mold, the melted material fed from the plasticizing device, wherein
the plasticizing device includes:
a plasticizing section that includes a feeding port for receiving the material and plasticizes the material to generate a melted material;
a material feeding section that includes a depositing port communicating with the feeding port and feeds the material from the depositing port to the plasticizing section; and
a blowing section that blows gas into a feeding path connecting the depositing port and the feeding port.

13. A three-dimensional shaping apparatus that shapes a three-dimensional shaped object, the three-dimensional shaping apparatus comprising:
a plasticizing device that plasticizes a material into a melted material;
a nozzle that discharges, toward a stage, the melted material fed from the plasticizing device; and
a control section, wherein
the plasticizing device includes:
a plasticizing section that includes a feeding port for receiving the material and plasticizes the material to generate a melted material;
a material feeding section that includes a depositing port communicating with the feeding port and feeds the material from the depositing port to the plasticizing section; and
a blowing section that blows gas into a feeding path connecting the depositing port and the feeding port.
